(19) United States
(12) Patent Application Publication
(10) Pub. No.: US 2026/0323803 A1
(43) Pub. Date: Oct. 15, 2026

(54) RADAR OCCUPANCY SENSOR

(71) Applicant: ABL IP HOLDING LLC, Atlanta, GA (US)

(72) Inventors: Frank D. Pelliccio, Guilford, CT (US); Richard L. Westrick, Jr., Social Circle, GA (US); Alan David Sanders, Atlanta, GA (US); Maurits van der Hoorn, Calgary (CA); Don Zulim, Conyers, GA (US); Alexis Boisserand, Hamden, CT (US)

(73) Assignee: ABL IP HOLDING LLC, Atlanta, GA (US)

(21) Appl. No.: 19/484,286

(22) PCT Filed: Apr. 1, 2025
(86) PCT No.: PCT/US2025/022491

§ 371 Date: Nov. 13, 2025

Related U.S. Application Data
(60) Provisional application No. 63/572,618, filed on Apr. 1, 2024.

(51) Int. Cl. H05B 47/13; F24F 11/00; F24F 120/10; G01S 13/04

(52) U.S. Cl. CPC H05B 47/13; F24F 11/00; G01S 13/04; F24F 2120/10

(57) ABSTRACT

A multi-modal sensor is configured to sense during an unoccupied state of a space, via one of an RF sensor or at least one other sensor, a first transition to an occupied state of the space. Multi-modal sensor is further configured to in response to sensing during the unoccupied state of the space the first transition to the occupied state of the space, enter a logical occupied state of the multi-modal sensor. Multi-modal sensor is further configured to determine during the logical occupied state of the multi-modal sensor, via the RF sensor, the at least one other sensor, or both, a second transition to an unoccupied state of the space. Multi-modal sensor is further configured to in response to determining during the logical occupied state of the multi-modal sensor the second transition to the unoccupied state of the space, enter a logical unoccupied state of the multi-modal sensor.

### CROSS-REFERENCE TO RELATED APPLICATIONS

This application claims priority to U.S. Provisional Patent Application No. 63/572,618, filed on Apr. 1, 2024, titled “Radar Occupancy Sensor,” the entire disclosure of which is incorporated by reference herein.

### TECHNICAL FIELD

The present subject matter relates to a multi-modal sensor that includes a radio frequency (RF sensor), such as a radar sensor, and at least one other sensor. The present subject matter also relates to radar sensing protocols and controls based on occupancy sensing for a variety of applications, such as lighting systems; heating, ventilation, and air conditioning (HVAC) systems; and security systems.

### BACKGROUND

There are currently several technologies used for occupancy and vacancy detection, including passive infrared (PIR), acoustic, and ultrasonic technologies. However, radar technology is not widely used, particularly in commercial buildings, due to a variety of problems. Unlike PIR or acoustic sensors, radar signals transmitted by radar sensors can penetrate through walls, ceilings, and floors. Consequently, a radar sensor may be falsely triggered by humans walking outside a room where a luminaire, HVAC system, or security system are located. A radar sensor is also an active detector in that radar sends out radar signals and receives reflections back, often detecting Doppler shift as part of the functionality. As an active detector, a radar sensor tends to consume more electrical power than passive detectors, such as PIR and acoustic sensors that are passive. For example, the radar sensor sends out RF signals very often, such as at least once a second or more, which requires more power than a PIR sensor and acoustic sensor. Hence, radar requires higher energy consumption than passive detectors.

Radar technology is very sensitive. Radar is negatively affected by vibration, for example, if a human is walking on a floor above the room in which a radar sensor is mounted in a multi-story building, there may be false triggering of a radar sensor for occupancy detection. Additionally, a radar sensor may falsely detect occupancy based on movement of a fan in a room, for example, if a flag or poster are moving around due to the air circulation from the fan.

### SUMMARY

Current state of the art radar sensors are insufficient for occupancy detection. Hence, there is a need for improvements to radar sensors for occupancy detection. A multi-modal sensor 123 described herein can provide the following advantages: (i) mitigation against vibration; (ii) mitigation against detection through walls; (iii) light detection without using a large passive infrared (PIR) lens; and (iv) low-power for battery powered applications.

In a first example, a lighting system 100 includes a luminaire 121. The luminaire 121 includes a light source 134 to emit illumination lighting for a space 120. The lighting system further includes a multi-modal sensor 123. The multi-modal sensor 123 includes a radio frequency (RF) sensor 162; and at least one other sensor 163A-N including a passive infrared (PIR) sensor, a carbon dioxide sensor, an acoustic sensor, an ultrasonic sensor, a thermal sensor, an active infrared (IR) sensor, a camera, an image sensor, an accelerometer, a gyroscope, an inertial measurement unit (IMU), or an induction loop detector. The multi-modal sensor 123 further includes a memory 160; a processor 161 coupled to the RF sensor 162, the at least one other sensor 163A-N, and the memory 160; and occupancy sensing programming 164 in the memory 160. Execution of the occupancy sensing programming 164 by the processor 161 configures the multi-modal sensor 123 to sense during an unoccupied state of the space 120, via one of the RF sensor 162 or the at least one other sensor 163A-N, a first transition to an occupied state of the space 120. Execution of the occupancy sensing programming 164 by the processor 161 configures the multi-modal sensor 123 to in response to sensing during the unoccupied state of the space 120 the first transition to the occupied state of the space 120, enter a logical occupied state 165 of the multi-modal sensor 123. Execution of the occupancy sensing programming 164 by the processor 161 configures the multi-modal sensor 123 to determine during the logical occupied state 165 of the multi-modal sensor 123, via the RF sensor 162, the at least one other sensor 163A-N, or both 162, 163A-N, a second transition to an unoccupied state of the space 120. Execution of the occupancy sensing programming 164 by the processor 161 configures the multi-modal sensor 123 to in response to determining during the logical occupied state 165 of the multi-modal sensor 123 the second transition to the unoccupied state of the space 120, enter a logical unoccupied state 166 of the multi-modal sensor 123.

In a second example, a system 600 includes a heating, ventilation, and air conditioning (HVAC) system 605 for a space 120. The HVAC system 610 includes HVAC equipment 610. The HVAC equipment 610 includes a heater 625, a fan 615, an air conditioner 615, 620, or a combination thereof. The system 600 further includes a multi-modal sensor 123. The multi-modal sensor 123 includes a radio frequency (RF) sensor 162; and at least one other sensor 163A-N including a passive infrared (PIR) sensor, a carbon dioxide sensor, an acoustic sensor, an ultrasonic sensor, a thermal sensor, an active infrared (IR) sensor, a camera, an image sensor, an accelerometer, a gyroscope, an inertial measurement unit (IMU), or an induction loop detector. The multi-modal sensor 123 further includes a memory 160; a processor 161 coupled to the RF sensor 162, the at least one other sensor 163A-N, and the memory 160; and occupancy sensing programming 164 in the memory 160. Execution of the occupancy sensing programming 164 by the processor 161 configures the multi-modal sensor 123 to sense during an unoccupied state of the space 120, via one of the RF sensor 162 or the at least one other sensor 163A-N, a first transition to an occupied state of the space 120. Execution of the occupancy sensing programming 164 by the processor 161 configures the multi-modal sensor 123 to in response to sensing during the unoccupied state of the space 120 the first transition to the occupied state of the space 120, enter a logical occupied state 165 of the multi-modal sensor 123. Execution of the occupancy sensing programming 164 by the processor 161 configures the multi-modal sensor 123 to determine during the logical occupied state 165 of the multi-modal sensor 123, via the RF sensor 162, the at least one other sensor 163A-N, or both 162, 163A-N, a second transition to an unoccupied state of the space 120. Execution of the occupancy sensing programming 164 by the processor 161 configures the multi-modal sensor 123 to in response to determining during the logical occupied state 165 of the multi-modal sensor 123 the second transition to the unoccupied state of the space 120, enter a logical unoccupied state 166 of the multi-modal sensor 123.

In a third example, a building control system 700 includes at least one building system 705A-N for a space 120. The at least one building system 705A-N includes a lighting system 100, an HVAC system 605, a security system 710, or a combination thereof. The at least one building system 705A-N includes building equipment 720A-B. The building control system 700 further includes a multi-modal sensor 123 to control the building equipment 720A-B. The multi-modal sensor 123 further includes a memory 160; a processor 161 coupled to the RF sensor 162, the at least one other sensor 163A-N, and the memory 160; and occupancy sensing programming 164 in the memory 160. Execution of the occupancy sensing programming 164 by the processor 161 configures the multi-modal sensor 123 to sense during an unoccupied state of the space 120, via one of the RF sensor 162 or the at least one other sensor 163A-N, a first transition to an occupied state of the space 120. Execution of the occupancy sensing programming 164 by the processor 161 configures the multi-modal sensor 123 to in response to sensing during the unoccupied state of the space 120 the first transition to the occupied state of the space 120, enter a logical occupied state 165 of the multi-modal sensor 123. Execution of the occupancy sensing programming 164 by the processor 161 configures the multi-modal sensor 123 to determine during the logical occupied state 165 of the multi-modal sensor 123, via the RF sensor 162, the at least one other sensor 163A-N, or both 162, 163A-N, a second transition to an unoccupied state of the space 120. Execution of the occupancy sensing programming 164 by the processor 161 configures the multi-modal sensor 123 to in response to determining during the logical occupied state 165 of the multi-modal sensor 123 the second transition to the unoccupied state of the space 120, enter a logical unoccupied state 166 of the multi-modal sensor 123.

In a fourth example, a non-transitory machine-readable medium 160 includes occupancy sensing programming 164. Execution of the occupancy sensing programming 164 configures a multi-modal sensor 123 to sense during an unoccupied state of the space 120, via one of an RF sensor 162 or at least one other sensor 163A-N, a first transition to an occupied state of the space 120. Execution of the occupancy sensing programming 164 configures the multi-modal sensor 123 to in response to sensing during the unoccupied state of the space 120 the first transition to the occupied state of the space 120, enter a logical occupied state 165 of the multi-modal sensor 123. Execution of the occupancy sensing programming 164 configures the multi-modal sensor 123 to determine during the logical occupied state 165 of the multi-modal sensor 123, via the RF sensor 162, the at least one other sensor 163A-N, or both 162, 163A-N, a second transition to an unoccupied state of the space 120. Execution of the occupancy sensing programming 164 configures the multi-modal sensor 123 to in response to determining during the logical occupied state 165 of the multi-modal sensor 123 the second transition to the unoccupied state of the space 120, enter a logical unoccupied state 166 of the multi-modal sensor 123.

In a fifth example, a method 400 includes sensing during an unoccupied state of a space 120, via one of an RF sensor 162 or at least one other sensor 163A-N, a first transition to an occupied state of the space 120. The method 400 further includes in response to sensing during the unoccupied state of the space 120 the first transition to the occupied state of the space 120, entering a logical occupied state 165 of the multi-modal sensor 123. The method 400 further includes determining during the logical occupied state 165 of the multi-modal sensor 123, via the RF sensor 162, the at least one other sensor 163A-N, or both 162, 163A-N, a second transition to an unoccupied state of the space 120. The method further includes in response to determining during the logical occupied state 165 of the multi-modal sensor 123 the second transition to the unoccupied state of the space 120, entering a logical unoccupied state 166 of the multi-modal sensor 123.

Additional objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities, and combinations particularly pointed out in the appended claims.

### BRIEF DESCRIPTION OF THE DRAWINGS

The drawing figures depict one or more implementations, by way of example only, not by way of limitations. In the figures, like reference numerals refer to the same or similar elements.

FIG. 1A depicts a lighting system that includes lighting system elements, such as multi-modal sensors, luminaires, and lighting control devices.

FIG. 1B depicts a lighting system like that of FIG. 1B; however, the multi-modal sensor is integrated or housed inside of the luminaires.

FIG. 2 is an isometric view of a luminaire mounted in a space and in communication with two different multi-modal sensors.

FIG. 3 depicts the lighting system that includes multi-modal sensors, luminaires, and lighting control devices located in a space.

FIG. 4 is an occupancy sensing protocol or method for the lighting system that is implemented by the multi-modal sensor and luminaires.

FIG. 5 is a block diagram of the multi-modal sensor.

FIG. 6 depicts a system like that of FIG. 1A, which includes multi-modal sensors; however, the system includes an HVAC system instead of luminaires and HVAC control devices instead of lighting control devices.

FIG. 7 depicts a building control system like that of FIGS. 1A and 6, which includes multi-modal sensors to control building systems.

### PARTS LISTING

100 Lighting System
104A-X Lighting System Elements
106 Illumination Lighting
108 Network
120 Space
121A-P Luminaires
122A-D Lighting Control Devices
123A-D Multi-Modal Sensors
130 Memory
131 Processor
132 Network Communication Interface
133 Driver Circuit
134 Light Source
135 Illumination Lighting
136 Lighting Control Programming
139 MCU
140 Memory
141 Processor
146 Switches or Touch Screen Display
155 Drive/Sense Circuitry
160 Memory
161 Processor
162 RF Sensor
163A-N Other Sensors
164 Occupancy Sensing Programming
165 Logical Occupied State
166 Logical Unoccupied State
185 Human
300A-B Locations
301A-B Rooms
305A-B Lighting Control Group/Zones
400 Occupancy Sensing Protocol/Method
501 Line Power Source
502 Non-Line Power Source
505 Power Supply
525 Power Distribution Circuitry
526 Low Standby Power Mode
527 Active Mode
530 Time Period
531A-N Occupancy Detection Signals
532 Combined Signal
533 Combined Occupancy Threshold
534 First Time Period
535 Second Time Period
536A-N Vibration Signals
562A-N RF Signals
563A-N Other Sensor Signals
600 System
605 HVAC System
610 HVAC Equipment
615 Fan
620 Condenser
625 Heater
622A-D HVAC Control Devices
636 HVAC Control Programming
700 Building Control System
705A-N Building Systems
710 Security System
720A-B Building Equipment

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The term “luminaire,” as used herein, is intended to encompass essentially any type of device that processes energy to generate or supply artificial light, for example, for general illumination of a space intended for use of occupancy or observation, typically by a living organism that can take advantage of or be affected in some desired manner by the light emitted from the device. However, a luminaire may provide light for use by automated equipment, such as sensors/monitors, robots, etc. that may occupy or observe the illuminated space, instead of or in addition to light provided for an organism. However, it is also possible that one or more luminaires in or on a particular premises have other lighting purposes, such as signage for an entrance or to indicate an exit. In most examples, the luminaire(s) illuminate a space or area of a premises to a level useful for a human in or passing through the space, e.g., of sufficient intensity for general illumination of a room or corridor in a building or of an outdoor space such as a street, sidewalk, parking lot or performance venue. The actual source of illumination light in or supplying the light for a luminaire may be any type of artificial light emitting device, several examples of which are included in the discussions below.

The term “lighting system,” as used herein, is intended to encompass essentially any type of system that either includes a number of such luminaires coupled together and/or luminaire(s) coupled together with one or more control devices, such as wall switches, control panels, remote controls, central lighting or building control systems, or servers.

Terms such as “artificial lighting” or “illumination lighting” as used herein, are intended to encompass essentially any type of lighting that a device produces by processing of electrical power to generate the light. A luminaire for an artificial lighting or illumination lighting application, for example, may take the form of a lamp, light fixture, or other luminaire arrangement that incorporates a suitable light source, where the lighting device component or source(s) by itself contains no intelligence or communication capability. The luminaire may contain a driver or control device that has intelligence and/or communications capability. Alternately, a non-intelligent luminaire may be electrically coupled to an intelligent load control device that is capable of processing communications from the lighting system. The illumination light output of an artificial illumination type luminaire, for example, may have an intensity and/or other characteristic(s) that satisfy an industry acceptable performance standard for a general lighting application.

The term “coupled” as used herein refers to any logical, physical, electrical, or optical connection, link or the like by which electricity, power, signals, or light produced or supplied by one system element are imparted to another coupled element. Unless described otherwise, coupled elements or devices are not necessarily directly connected to one another and may be separated by intermediate components, elements, or communication media that may modify, manipulate or carry the electricity, power, signals, or light.

The orientations of the lighting system 100, lighting system elements 104A-X, luminaires 121A-P, lighting control devices 122A-D, multi-modal sensors 123A-D, associated components, and/or any complete devices, such as shown in any of the drawings, are given by way of example only, for illustration and discussion purposes. In operation for a particular lighting application, lighting system elements 104A-X may be oriented in any other direction suitable to the particular application of the lighting system 100, for example upright, sideways, or any other orientation. Also, to the extent used herein, any directional term, such as left, right, front, rear, back, end, up, down, upper, lower, top, bottom, and side, are used by way of example only, and are not limiting as to direction or orientation of any lighting system 100 or lighting system elements 104A-X; or component of a lighting system 100 or lighting system elements 104A-X constructed as otherwise described herein.

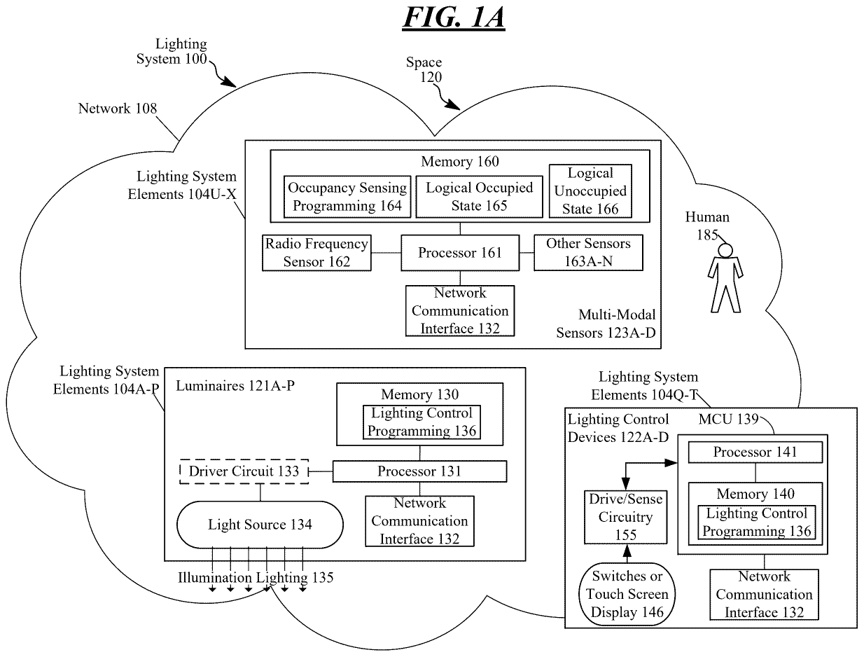

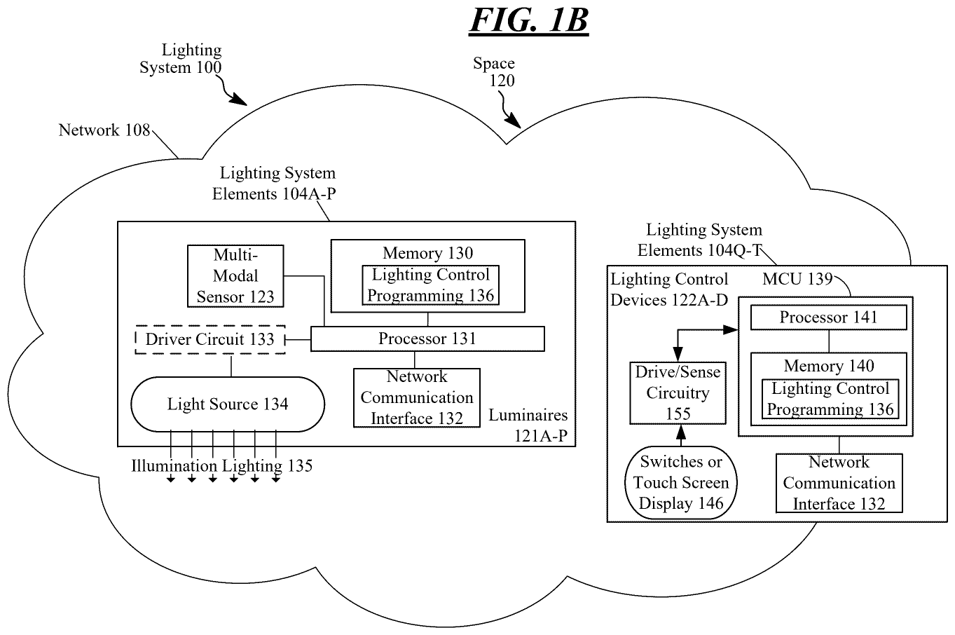

Unless otherwise indicated, any embodiment can be combined with any other embodiment. In particular, FIGS. 1A-7 and the associated text are all combinable with each other. Reference now is made in detail to the examples illustrated in the accompanying drawings and discussed below.

FIG. 1A depicts a lighting system 100 that includes lighting system elements 104A-X, such as multi-modal sensors 123A-D. Lighting system elements 104A-X of the lighting system 100 are located in a space 120, such as a building. In the example, lighting system elements 104A-P are luminaires 121A-P; lighting system elements 104Q-T are lighting control devices 122A-D; and lighting system elements 104U-X are multi-modal sensors 123A-D. Luminaires 121A-P illuminate the space 120 of a premises to a level useful for a human 185 in or passing through the space 120, e.g. general illumination of the space 120, such as a warehouse, room, or a corridor in a building; or of an outdoor space such as a street, sidewalk, parking lot, or performance venue. Lighting control devices 122A-D can be wall switches, hand-held switches, or touch screen devices to turn on/off or dim luminaires 121A-P. Multi-modal sensors 123A-D can enable controls for on/off and dimming of the luminaires 121A-P based on occupancy sensing in the space 120.

As shown, luminaires 121A-P include a light source 134 to emit illumination lighting 135 for the space 120; and an optional driver circuit 133 coupled to the light source 134 to control operation of the light source 134. In some examples, the luminaires 121A-P may include a ballast instead of the driver circuit 133 depending on the type of light source 134 (e.g., for a fluorescent or incandescent light bulb).

Light source 134 can include electrical-to-optical transducers, such as various light emitters for illumination lighting 135. The emitted light may be in the visible spectrum or in other wavelength ranges. Suitable light generation sources for the light source 135 include various conventional lamps, such as incandescent, fluorescent or halide lamps; one or more light emitting diodes (LEDs) of various types, such as planar LEDs, organic LEDs (OLEDs), micro LEDs, micro OLEDs, LEDs on gallium nitride (GaN) substrates, micro nanowire or nanorod LEDs, photo pumped quantum dot (QD) LEDs, micro plasmonic LED, micro resonant-cavity (RC) LEDs, and micro photonic crystal LEDs; as well as other sources such as micro super luminescent diodes (SLD) and micro laser diodes. Of course, these light generation technologies are given by way of non-limiting examples, and other light generation technologies may be used. For example, it should be understood that non-micro versions of the foregoing light generation sources can be used.

Luminaires 121A-P further include a network communication interface 132 configured for communication, for example, over the network 108 (e.g., a wired or wireless network), with the multi-modal sensors 123A-D. The luminaires 121A-P further include a memory 130; and a processor 131 coupled to the light source 134, network communication interface 132, and the memory 130. The luminaires 121A-P further include lighting control programming 136 in the memory 130 to control the light source 134 and communicate with other lighting system elements 104Q-X, such as lighting control devices 122A-D and multi-modal sensors 123A-D.

As shown, each of the multi-modal sensors 123A-D includes a radio frequency (RF) sensor 162; and at least one other sensor 163A-N. The RF sensor 162 can include any radio-frequency based presence detection technologies, including radar, ultra-wide band (UWB), WiFi, etc. The at least one other sensor 163A-N can include a passive infrared (PIR) sensor, a carbon dioxide sensor, an acoustic sensor, an ultrasonic sensor (e.g., 42 kHz), a thermal sensor, an active infrared (IR) sensor, a camera, an image sensor, an accelerometer, a gyroscope, an inertial measurement unit (IMU), or an induction loop detector. For example, the at least one other sensor 163A-N can include one or more sensing technologies, and hence include a first sensor 163A, a second sensor 163B, a third sensor 163C, etc. The combination of the RF sensor 162 with the at least one other sensor 163A-N can be used to reliably turn on the light source 134 of the luminaires 121A-P when a human 185 enters the space 120, keep the light source 134 on when the human 185 remains in the space 120, and turn the light source 134 off when the human exits the space 120.

The multi-modal sensor 123 can implement a variety of combinations of the RF sensor 162 and the at least one other sensor 163A-N. For example, the RF sensor 162 can be coupled to an infrared sensor, ultrasonic proximity sensor, LIDAR sensor, infrared time of flight (ToF) sensor, or other sensing technologies. For example, the RF sensor 162 can be a radar sensor combined with a PIR sensor 163A, a carbon dioxide sensor 163B, an acoustic sensor 163C, an ultrasonic sensor 163D, a thermal sensor 163E, an active IR sensor 163F, a camera 163G, or a combination thereof. Combining the radar sensor with an ultrasonic sensor 163D allows the multi-modal sensor 123 to see through walls of a cubicle to detect a human 185 which is difficult with an ultrasonic sensor 163D alone. The at least one other sensor 163A-N can also be another RF sensor, such as WiFi or Bluetooth™ which can be combined with a radar sensor serving as the RF sensor 162 to eliminate the poor aesthetics of the hemispherical (e.g., wart) shaped lens of a PIR sensor 163A.

Multi-modal sensors 123A-D further include a memory 160, for example, volatile and non-volatile memory; and a processor 161, such as a central processing unit (CPU). Multi-modal sensors 123A-D have the processor 161 coupled to the RF sensor 162, the at least one other sensor 163A-N, and the memory 160. In the example of FIG. 1A, multi-modal sensors 123A-D further include a network communication interface 132 coupled to the processor 161 for communication over the network 108. Multi-modal sensors 123A-D further include occupancy sensing programming 164 in the memory 160 for sensing occupancy and to communicate with other lighting system elements 104A-T, such as luminaires 121A-P and lighting control devices 122A-D.

Execution of the occupancy sensing programming 164 by the processor 161 configures the multi-modal sensor 123 to sense during an unoccupied state of the space 120, via one of the RF sensor 162 or the at least one other sensor 163A-N, a first transition to an occupied state of the space 120. Execution of the occupancy sensing programming 164 by the processor 161 configures the multi-modal sensor 123 to in response to sensing during the unoccupied state of the space 120 the first transition to the occupied state of the space 120, enter a logical occupied state 165 of the multi-modal sensor 123. As used herein, the term “logical” when referring to state can mean a state of the multi-modal sensor 123 as opposed to actual human presence or absence and the actual on/off state of the light source 134 of luminaires 121A-P. The multi-modal sensors 123A-D can be configured to not automatically turn on the luminaires 121A-P when occupancy is detected, but rather make the occupants turn the luminaires 121A-P on manually. Likewise, it is common for occupants to turn the luminaires 121A-P off manually and then remain in the space 120 for an audio/video presentation (or nap time, in a school setting).

Execution of the occupancy sensing programming 164 by the processor 161 configures the multi-modal sensor 123 to determine during the logical occupied state 165 of the multi-modal sensor 123, via the RF sensor 162, the at least one other sensor 163A-N, or both 162, 163A-N, a second transition to an unoccupied state of the space 120. Execution of the occupancy sensing programming 164 by the processor 161 configures the multi-modal sensor 123 to in response to determining during the logical occupied state 165 of the multi-modal sensor 123 the second transition to the unoccupied state of the space 120, enter a logical unoccupied state 166 of the multi-modal sensor 123.

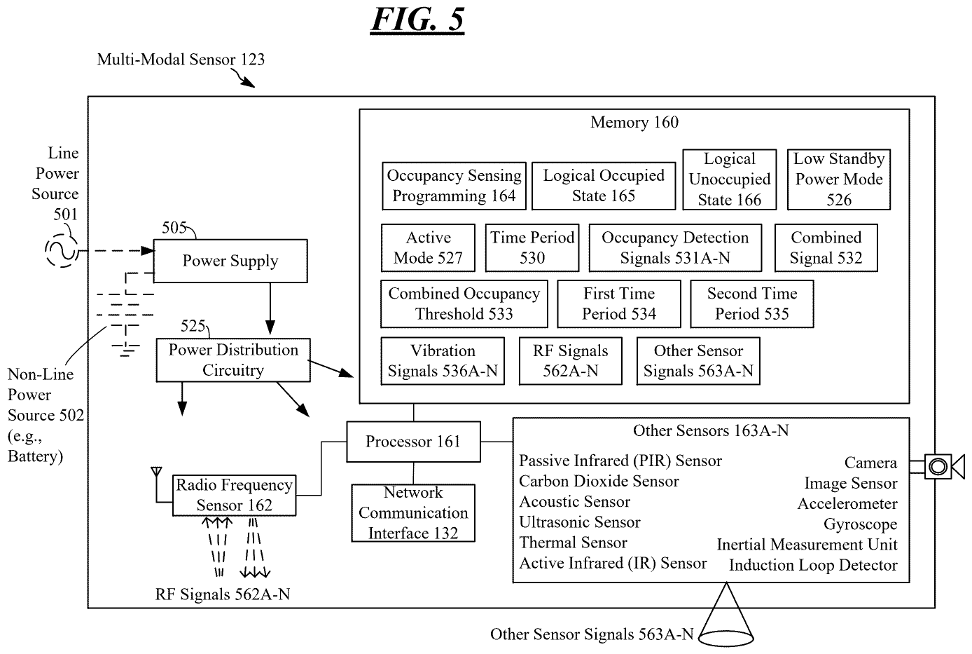

In some examples, the at least one other sensor 163A-N can implement a broad sweep of the space 120, or be configured to detect large motions (such as walking) in the space 120 to detect occupancy and the RF sensor 162, such as a radar sensor, can implement a more granular sweep or be configured to detect smaller motions (such as typing). For example, the light source 134 of the luminaires 121A-P can be initially turned on when a PIR sensor 163A detects occupancy and then the light source 134 can be kept on or turned off by the radar sensor. In another example, the radar sensor can initially turn on the light source 134 and a carbon dioxide sensor 163B can keep the light source 134 on or turn it off. As further described in FIG. 5 below, timeouts, such as a time period 530, a first time period 534, and a second time period 535 can be applied to the RF sensor 162 and the at least one other sensor 163A-N to avoid false occupancy detection and thereby incorrectly turning on and off the light source 134 of luminaries 121A-P.

As shown, each of the lighting control devices 122A-D includes an on-board micro-control unit (MCU) 139 that includes a memory 140 (volatile and non-volatile) and a processor 141. The lighting control devices 122A-D further include lighting control programming 136 in the memory 130 to communicate with other lighting system elements 104A-P, 104U-X, such as luminaires 121A-P and multi-modal sensors 123A-D.

Lighting control devices 122A-D have the MCU 139 coupled to drive/sense circuitry 155 operable to control a network communication interface 132 and switches or touch screen display 146. Lighting control devices 122A-D can be a wall switch where the drive/sense circuitry 155 responds to switches 146. Switches 146 can be an on/off switch, dimmer switch, or set scene. Switches 146 can be a single shared button switch for on/off, dimming, or set scene functions. A button station can include various button settings that can have the lighting control settings adjusted, for example, four buttons can be arranged with two longitudinal buttons (north-south) and two lateral buttons (east-west). Alternatively, lighting control devices 122A-D can be a touchscreen device in which lighting control setting adjustments are inputted via a user interface application (not shown) through manipulation or gestures on a touch screen display 146.

FIG. 1B depicts a lighting system 100 like that of FIG. 1B; however, the multi-modal sensor 123 is integrated or housed inside of the luminaires 121A-P. Hence, the multi-modal sensor 123 can include a network communication interface 132 for communication over a network 108 with the luminaire 121 like that shown in FIG. 1A or the multi-modal sensor 123 can be integrated or housed inside of the luminaire 121 like that shown in FIG. 1B.

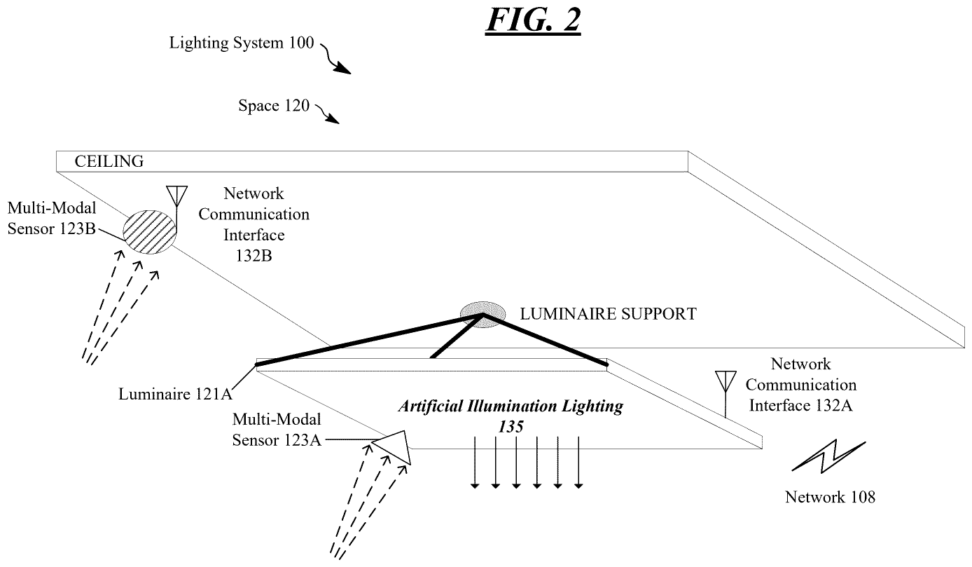

FIG. 2 is an isometric view of a luminaire 121A mounted in the space 120 and in communication with two different multi-modal sensors 123A-B. As shown, the luminaire 121A includes a first multi-modal sensor 123A that is integrated or housed inside of the luminaire 123A and a first network communication interface 132A for communication over the network 108. A conventional PIR sensor is typically mounted and visible in plain sight to a human 185 walking through the space 120 regardless of whether the conventional PIR sensor is mounted on the luminaire 121A or a standalone PIR sensor attached to the ceiling or walls of the space 120.

The conventional PIR sensor includes a hemispherical (wart) shape, which is not considered aesthetically pleasing to the human 185. In an example, having the multi-modal sensor 123A include a combination of a radar sensor as the RF sensor 162 and the PIR sensor 163A as the at least one other sensor 163A-N can remedy the aesthetic shortcomings of the conventional PIR sensor alone by enabling the PIR sensor 163A of the multi-modal sensor 123A to have a lens with a flatter shape that is substantially planar as opposed to substantially curved like the conventional PIR sensor. Although the flatter lens shape of the PIR sensor 163A will have a narrower field of view, the radar sensor has a much broader field of view to remedy the narrower field of view shortcomings of the PIR sensor 163A of the multi-modal sensor 123A. Consequently, the PIR sensor 163A can be less intrusive (e.g., smaller with less protruding surface area from a luminaire, wall, or ceiling) because the substantially planar lens does not require the same viewing angle as the hemispherical shaped lens of the conventional PIR sensor.

The lighting system 100 further includes a second multi-modal sensor 123B that is a standalone sensor, which includes a second network communication interface 132B for communication over the network 108 with the luminaire 121A. Hence, multi-modal sensors 123A-B can be mounted on the ceiling or walls of the space 120, independent of the luminaire 121A; therefore, the multi-modal sensors 123A-B are not limited to luminaire mounted applications.

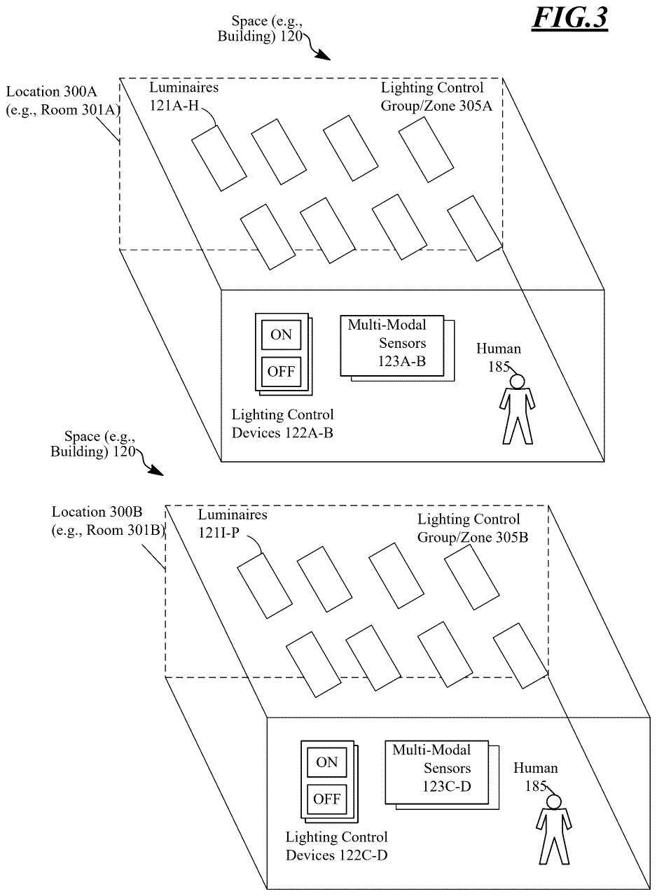

FIG. 3 depicts the lighting system 100 that includes multi-modal sensors 123A-D, luminaires 121A-P, and lighting control devices 122A-D located in the space 120. In the example, luminaires 121A-P illuminate the space 120 of a premises to a level useful for an observer, such as a human 185, in or passing through locations 300A-B in the space 120, such as a warehouse, room, or a corridor in a building; or of an outdoor space such as a street, sidewalk, parking lot or performance venue. Lighting control devices 122A-D can be wall switches or touch screen devices to turn on/off or dim luminaires 121A-P. Multi-modal sensors 123A-D can enable controls for on/off and dimming of the luminaires 121A-P via occupancy sensing.

As shown in FIG. 3, the space 120 includes a plurality of locations 300A-B. In the example of FIG. 3, the locations 300A-B include two different rooms 301A, 301B. A first room 301A includes luminaires 121A-H, lighting control devices 122A-B, and multi-modal sensors 123A-B. A second room 301B includes luminaires 121I-P, lighting control devices 122C-D, and multi-modal sensors 123C-D. Accordingly, in the occupancy sensing protocol 400, the lighting control groups/zones 305A-N (and assigned network addresses) can be tied to locations 300A-B of the lighting system elements 104A-X.

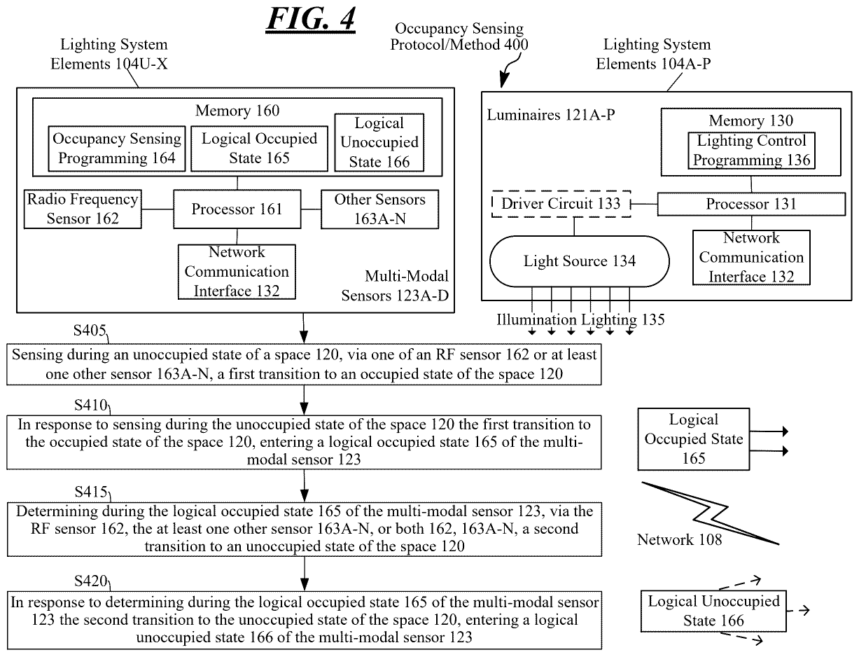

FIG. 4 is an occupancy sensing protocol/method 400 for the lighting system 100 that is implemented by the multi-modal sensor 123 and luminaires 121A-P. In the example of FIG. 4, the occupancy sensing protocol 400 is implemented in the occupancy sensing programming 164 of the multi-modal sensor 123. Execution of the occupancy sensing programming 164 stored in a memory 160 by a processor 161 of the multi-modal sensor 123 configures the multi-modal sensor to implement blocks S405, S410, S415, and S420 described below.

Beginning in block S405, the occupancy sensing protocol 400 includes sensing during an unoccupied state of a space 120, via one of an RF sensor 162 or at least one other sensor 163A-N, a first transition to an occupied state of the space 120. A light source 134 of the luminaire 121 may be turned off during the unoccupied state of the space 120. In an example, the at least one other sensor includes a PIR sensor 163A. The sensing during the unoccupied state of the space 120, via the one of the RF sensor 162 or the at least one other sensor 163A-N, the first transition to the occupied state of the space 120 includes sensing during the unoccupied state of the space 120, via the PIR sensor 163A, occupancy of the space 120 by at least one human 185.

Moving to block S410, the occupancy sensing protocol 400 further includes in response to sensing during the unoccupied state of the space 120 the first transition to the occupied state of the space 120, entering a logical occupied state 165 of the multi-modal sensor 123. The light source 134 of the luminaire 121 may be turned on during the logical occupied state 165 of the multi-modal sensor 123.

Continuing to block S415, the occupancy sensing protocol 400 further includes determining during the logical occupied state 165 of the multi-modal sensor 123, via the RF sensor 162, the at least one other sensor 163A-N, or both 162, 163A-N, a second transition to an unoccupied state of the space 120. In an example, the determining during the logical occupied state 165 of the multi-modal sensor 123, via the RF sensor 162, the at least one other sensor 163A-N, or both 162A-N, 163A-N, the second transition to the unoccupied state of the space 120 includes determining during the logical occupied state 165, via the RF sensor 162, non-occupancy of the space 120 by at least one human 185.

Finishing now, in block S420, the occupancy sensing protocol 400 further includes in response to determining during the logical occupied state 165 of the multi-modal sensor 123 the second transition to the unoccupied state of the space 120, entering a logical unoccupied state 166 of the multi-modal sensor 123. The light source 134 of the luminaire 121 may be turned off during the logical unoccupied state 166 of the multi-modal sensor 123.

FIG. 5 is a block diagram of the multi-modal sensor 123. As shown, the multi-modal sensor 123 includes a power supply 505 that is optionally driven by a line power source 501 and optionally a non-line power source 502. A line power source 501 is referred to as grid power, wall power, and domestic power, alternating current (AC) electric power produced and delivered via AC mains to homes and businesses. Line power source 501 is the form of electrical power that consumers use when they plug in domestic appliances, televisions and electric lamps into wall outlets. Line power source 501 conveys line power (e.g., 120 volts alternating current (VAC), 240 VAC, 277 VAC, 347 VAC, or up to 480 VAC in industrial or commercial buildings), sometimes referred to as “household power,” “household electricity,” “house current,” “powerline,” “domestic power,” “wall power,” “line power,” “AC power,” “city power,” “street power” that is produced by an electric utility provider. Non-line power source 502 in the example is a battery, solar panel, or any other AC or DC source (e.g., a generator) that is not line powered.

Power supply 505 may include a magnetic transformer, electronic transformer, switching converter, rectifier, or any other similar type of circuit to convert an input power signal into a power signal suitable for the multi-modal sensor 123 and components. Multi-modal sensor 123 includes power distribution circuitry 525 driven by the line power source 501 or non-line power source 502. The power distribution circuitry 525 distributes power and ground voltages to the processor 160; memory 161; network communication interface 132; RF sensor 162; and other sensors 163A-N to provide reliable operation of the various circuitry on the multi-modal sensor 123. Processor 161 includes a central processing unit (CPU) that controls the RF sensor 162 and other sensors 163A-N. Memory 160 can include volatile and/or non-volatile storage.

RF sensor 162 can utilize radio waves to determine the distance (ranging), direction (azimuth and elevation angles), radial velocity relative to the RF sensor 162, or a combination thereof. The radar sensor can include a transceiver that includes an RF transmitter and an RF receiver. In an example, the RF sensor 162 can include a radar sensor. The radar sensor includes an RF transmitter that emits RF signals 562A-N, such as radar signals, in predetermined directions. When the radar signals contact objects, the radar signals are usually reflected or scattered in many directions, although some of the radar signals might be absorbed and penetrate into the object. The RF receiver can be located in the same location as the RF transmitter (co-located), but the RF receiver and RF transmitter may be separately located in some examples. The RF receiver captures reflected radar signals from objects. The weak absorption of RF signals 562A-N by the medium through which the RF signals 562A-N pass allows the radar sensor to detect objects at longer ranges unlike other electromagnetic wavelengths, such as infrared.

The frequency of the radar sensor can be from approximately 5 megahertz (MHz) up to 130 gigahertz (GHz). In some examples, the radar sensor can operate between 3-30 MHz (high frequency band), 30-300 MHz (very high frequency band), <300 MHz (previous band−high frequency+very high frequency), 300-1,000 MHz (ultra-high frequency band), 1-2 GHz (long band), 2-4 GHz (sentimetric band−moderate range band), 4-8 GHz (compromise band), 8-12 GHz (X band), 12-18 GHz (Kᵤ band), 18-24 GHz (K band), 24-40 GHz (Kₐ band), 40-75 GHz (V band), 75-110 GHz (W band), or any other known bands for radar technology. The at least one other sensor 163A-N senses other sensor signals 563A-N, such as infrared waves 563A for a PIR sensor 163A, carbon dioxide levels 563B for a carbon dioxide sensor 163B, sound waves 563C for an acoustic sensor 163C, etc. to detect occupancy of the space 120.

Multi-modal sensor 123 can combine the RF signals 562A-N and other sensor signals 563A-N logically to create an advantageous result. One way to combine is to have the at least one other sensor 163A-N include a PIR sensor 163A to turn the light source 134 of the luminaire 121 on. Then combination of technologies of the RF sensor 162 and the at least one other sensor 163A-N can together keep the light source 134 of the luminaire 121 on based on a set time period 530, such as from one minute to an hour, to ensure motion from people in the room of the space 120 is seen. The time period 530 can be configured at any suitable occupancy time delay or range. If either the RF sensor 162 or the at least other sensor 163A-N has a hit (e.g., detects occupancy) in the time period 530, then the light source 134 of the luminaire 121 is kept on. For example, if there is a hit on either one of the RF sensor 162 or the at least one other sensor 163A-N in the time period 530, such as twenty minutes, and a hit is seen on the PIR sensor 163A every twelve to fifteen minutes, then the light source 134 of the luminaire 121 is kept on.

In an example multi-modal sensor 123, the at least one other sensor 163A-N includes the PIR sensor 163A. The sensing during the unoccupied state of the space 120, via the one of the RF sensor 162 or the at least one other sensor 163A-N, the first transition to the occupied state of the space 120 includes sensing during the unoccupied state of the space 120, via the PIR sensor 163A, occupancy of the space 120 by at least one human 185. The RF sensor 162 includes a radar sensor. The determining during the logical occupied state 165 of the multi-modal sensor 123, via the RF sensor 162, the at least one other sensor 163A-N, or both 162, 163A-N, the second transition to the unoccupied state of the space 120 includes determining during the logical occupied state 165, via the radar sensor, non-occupancy of the space 120 by the at least one human 185.

Having the multi-modal sensor 123 include a combination of a radar sensor as the RF sensor 162 and the PIR sensor 163A as the at least one other sensor 163A-N can remedy shortcomings of both radar and PIR sensors alone. When a human 185 initially enters the space 120, the PIR sensor 163A can sense the human 185. The multi-modal sensor 123 can then enter a logical occupied state 165, which can result in the light source 134 of the luminaire 121A being turned on. If after entering the space 120, the human 185 sits at a desk in a cubicle with high cubicle walls for several hours and types on a keyboard, the PIR sensor 163A does not sense the human 185 is in the space 120 anymore, which would result in the PIR sensor 163A eventually timing out and turning the light source 134 of the luminaire 121A off. However, with the radar sensor of the multi-modal sensor 123, the minor hand movements of the human 185 typing on the keyboard are sensed. Hence, the multi-modal sensor 123 remains in the logical occupied state 165 and the light source 134 of the luminaire 121A stays on. In addition, the radar sensor can initially be in the low standby power mode 526 until the PIR sensor 163A senses the human 185, which can conserve battery power if the multi-modal sensor 123 is powered by a non-line power source 502 (e.g., battery) or enable the multi-modal sensor 123 to comply with energy efficiency standards.

In an example multi-modal sensor 123, during the unoccupied state of the space 120, the RF sensor 162 is in a low standby power mode 526. Upon entering the logical occupied state 165 of the multi-modal sensor 123, the RF sensor 162 enters an active mode 527. For example, the low standby power mode 526 can conserve battery life of the multi-modal sensor 523 or enable compliance with an energy efficiency standard. The active mode 527 awakens the RF sensor 162 from a deep sleep, such that the RF sensor 162 enters a higher power mode to detect occupancy. Such a technique is beneficial as the RF sensor 162 based on radar can consume significant electrical power as an active detector.

In an example multi-modal sensor 123, the determining during the logical occupied state 165, via the RF sensor 162, the at least one other sensor 163A-N, or both 162, 163A-N, the second transition to the unoccupied state of the space 120 includes determining that both of the RF sensor 162 and the at least one other sensor 163A-N have not detected occupancy of the space 120 for a time period 530 by at least one human 185. The determining that both of the RF sensor 162 and the at least one other sensor 163A-N have not detected occupancy of the space 120 for the time period 530 by the at least one human 185 includes the following. First, combining occupancy detection signals 531A-N from the RF sensor 162 and the at least one other sensor 163A-N into a combined signal 532, for example, the combining can include adding the occupancy detection signals 531A-N together. Second, comparing the combined signal 532 against a combined occupancy threshold 533 to detect the occupied state. Third, determining that the combined signal 532 does not satisfy the combined occupancy threshold 533 during the time period 530.

Alternatively, the multi-modal sensor 123 can determine that both of the RF sensor 162 and the at least one other sensor 163A-N have detected occupancy of the space 120 for a time period 530 by at least one human 185. In this example, the combined signal 532 may satisfy the combined occupancy threshold 533 during the time period 530. Because the radar sensor is more sensitive, the radar sensor can keep the multi-modal sensor 123 in a logical occupied state 165 by resetting a timer that is compared against the time period 530. This stops the PIR sensor 163A from timing out and keeps the state of the multi-modal sensor 123 in the logical occupied state 165 based on occupancy detection.

A machine learning algorithm of the occupancy sensing programming 164 can learn patterns of the occupancy detection signals 531A-N, the combined signal 532, and the combined occupancy threshold 533 depending on the signature of the radar sensor with the frequency of hits on the PIR sensor 163A to learn what type of combined signal 532 to expect. For example, if there is no hit (detected occupancy) on the PIR sensor 163A in a long time but the radar sensor continues to have hits, then the occupancy sensing programming 164 increases the combined occupancy threshold 533 to eliminate potential vibration of the radar sensor. In another example, the occupancy sensing programming 164 can machine learn based on the pattern of human occupancy in the space 120. For example, the occupancy sensing programming 164 can determine at which times of day there are people in the space 120.

In an example multi-modal sensor 123, the determining during the logical occupied state 165 of the multi-modal sensor 123, via the RF sensor 162, the at least one other sensor 163A-N, or both 162, 163A-N, the second transition to the unoccupied state of the space 120 includes the following. First, determining that the RF sensor 162 has not detected occupancy of the space 120 for a first time period 534 by at least one human 185. Second, determining that the at least one other sensor 163A-N has not detected occupancy of the space 120 for a second time period 535 by the at least one human 185. The second time period 535 is greater than the first time period 534. For example, if the RF sensor 162 includes a radar sensor then the first time period 534 may be two minutes for the radar sensor because of the high sensitivity. If the at least one other sensor 163A-N includes a PIR sensor 163A, then the second time period 535 can be two hours for the PIR sensor 163A due to the lower sensitivity. Occupancy sensing programming 164 can apply machine learning to evaluate signals 562A-N, 563A-N from the different sensors 162, 163A-N, such as the RF sensor 162 and the at least one other sensor 163A-N, to derive optimal sensitivity and timeout settings for each detection technology after installation.

The first time period 534 can include a shorter timeout period which needs a hit for the radar sensor because the radar sensor tends to provide many hits in a short period of time, but the second time period 535 can have a longer cadence, such as every fifteen minutes to require a hit from the PIR sensor 163A. If a first human 185A walks in the room of the space 120, picks up an object from a desk, and walks out of the space 120, then the PIR sensor 163A will have a hit and a timer for the PIR sensor 163A is reset. If a second human 185B in the next desk over keeps moving, then the radar sensor registers a hit and a timer for the radar sensor is reset. If after the second time period 535, such as fifteen minutes, there is no hit on the PIR sensor 163A, then the light source 134 of the luminaire 121 is turned off. The second time period 535 of the PIR sensor 163A can be used to overcome false occupancy detection by the radar sensor of people in the next room over that is not in the space 120 or a fan blowing in the space 120 because radar picks up any motion, but in this case the PIR sensor 163A does not register a hit. The first time period 534 of the radar sensor can avoid the problem where a human 185 is in the space 120 but is very still and merely typing on a keyboard at the desk, in this case the PIR sensor 163A does not register a hit, but the radar sensor will. Another advantage of combining the radar sensor with the PIR sensor 163A is that the radar sensor takes more power, so the PIR sensor 163A can wakeup the radar sensor from a low standby power mode 526. Alternatively, the acoustic sensor 163C can wake up the radar sensor from the low standby power mode 526. The multi-modal sensor 123 is not just for battery applications, for example, there may be an incentive program to have low standby power when the light source 134 of the luminaire 121 is turned off. With the dual technology multi-modal sensor 123, a low energy PIR sensor 163A can be used and the radar sensor can be switched on when the light source 134 of the luminaire 121 is turned on.

Occupancy sensing programming 164 can apply a machine learning algorithm to adjust the sensitivity of the radar sensor based on the first time period 534 of the radar sensor or the second time period 535 of the at least one other sensor 163A-N. For example, if a hit is not seen in the PIR sensor 163A, then the gain can be lowered in the radar sensor. If the PIR sensor 163A does not have a hit, then the occupancy sensing programming 164 can adjust settings of the radar sensor, such as the distance (e.g., envelope), signal strength to detect a hit, or polling rate to determine whether the logical occupied state 165 is detected, for example, to turn on the light source 134 of the luminaire 121. For example, if there are many hits on the radar sensor but no hits on the PIR sensor 163A, the occupancy sensing programming 164 may determine the hits on the radar sensor are false. From a power savings standpoint, if the radar sensor is left on at the normal high polling rate but there has not been a hit on the PIR sensor 163A in a second time period 535, then the polling rate or sensitivity of the radar sensor can be lowed so not as much power is used. Turning down the sensitivity of the radar sensor can eliminate false positives of people that are in another room that is not in the space 120.

In an example multi-modal sensor 123, the sensing during the unoccupied state of the space 120, via the one of the RF sensor 162 or the at least one other sensor 163A-N, the first transition to the occupied state of the space 120 includes sensing, via the RF sensor 162, occupancy of the space 120 by at least human 185. The at least one other sensor 163A-N includes the carbon dioxide sensor 163B. The determining during the logical occupied state 165 of the multi-modal sensor 123, via the RF sensor 162, the at least one other sensor 163A-N, or both 162A-N, 163A-N, the second transition to the unoccupied state of the space 120 includes determining, via the carbon dioxide sensor 163B, non-occupancy of the space 120 by the at least human 185.

To mitigate against false detections caused by vibrations, the multi-modal sensor 123 can be equipped with a combination of sensing technologies, e.g., combining the RF sensor 162, such as a radar sensor with at least one other sensor 163A-N. In the example, the RF sensor 162 can be combined with the at least one other sensor 163A-N in a single piece of hardware in the multi-modal sensor 123, but can also be separate. The at least one other sensor 163A-N can include PIR, microphonics, ultrasonic, thermal, IR array, and or camera sensing to improve sensitivity and reduce false-positives. For example, radar sensors are very sensitive to vibration and may falsely detect occupancy based on vibration. In contrast, a PIR sensor 163A and acoustic sensor 163C are typically passive only and not negatively impacted by the vibration of the multi-modal sensor 123 or building structure of the space 120, for example, due to movement of HVAC systems, machinery, or equipment.

Having the multi-modal sensor 123 include a combination of a radar sensor as the RF sensor 162 and the carbon dioxide sensor 163B as the at least one other sensor 163A-N can remedy shortcomings of both radar and carbon dioxide sensors alone. When a human 185 initially enters the space 120, the radar sensor can sense the human 185. The multi-modal sensor 123 can then enter a logical occupied state 165, which can result in the light source 134 of the luminaire 121A being turned on. However, radar signals can be long range and penetrate through walls into other rooms, hallways, and may falsely detect occupancy in the space 120 if the human 185 leaves the space 120 and enters another room or a hallway. If after entering the space 120, the human 185 enters an adjacent room and sits at a desk in a cubicle for several hours and types on keyboard, the radar sensor would falsely detect occupancy because radar can see through walls, ceilings, and floors. However, the carbon dioxide sensor 163B can sense that the carbon dioxide level in the room of the space 120 has not changed (remained static) or is decreasing since the human entered the space 120 over the time period 530. Hence, the multi-modal sensor 123 will enter the logical unoccupied state 166 based on the carbon dioxide sensor 163B sensing the carbon dioxide level is unchanged or is decreasing. If the human 185 had stayed in the space 120, the carbon dioxide level would have increased.

In an example, the RF sensor 162 includes the radar sensor. The at least one other sensor 163A-N includes a vibration sensing device, such as a gyroscope, accelerometer, or a combination thereof (for example, an inertial measurement unit, which can also include a magnetometer). Execution of the occupancy sensing programming 164 by the processor 161 causes the multi-modal sensor 123 to receive vibration signals 536A-N corresponding to vibrations of the radar sensor, measured via the vibration sensing device. The sensing during the unoccupied state of the space 120, via the one of the RF sensor 162 or the at least one other sensor 163A-N, the first transition to the occupied state of the space 120 and the determining during the logical occupied state 165 of the multi-modal sensor 123, via the radar sensor 162, the at least one other sensor 163A-N, or both 162, 163A-N, the second transition to the unoccupied state of the space can include filtering the vibration signals 536A-N. The radar sensor detects vibration due to small changes in distance and Doppler shift. The vibrations and movement that are desired to be detected do not have sustained constant characteristics for longer than a few seconds. However, vibrations that the multi-modal sensor 123 should ignore are continuous and steady. Those vibrations have the same frequency characteristics over a long period of time. These vibrations can be removed using two filtering paradigms implemented by the occupancy sensing programming 164. The first mode of filtering would remove frequencies that should be ignored. Those frequencies are ones that show up over long periods of time with consistent frequency characteristics. One example of a digital filter that accomplishes that is a finite impulse response (FIR) filter, tuned to remove high frequency or specific frequency signals. For example, digital filtering can remove vibration signals 536A-N through a low bandpass filter. One method of determining the filter coefficients of a digital filter, like an FIR filter, is to use a multi-staged adaptive filtering algorithm. An adaptive filter adjusts its frequency response automatically according to a predetermined performance criterion. This usually means that the filter coefficients are adjusted to reduce the energy created by vibrations at the output of the processed signal. A multi-staged adaptive filtering algorithm can also be used by the occupancy sensing programming 164 to create an interference signal to the noisy vibrational signal being received. Using this method, the algorithm creates an opposite signal to cancel out the undesired signal.

Occupancy sensing programming 164 can measure vibrations on the structure holding the radar sensor with a gyroscope and accelerometer of the at least one other sensor 163A-N to eliminate false occupancy detection from the multi-modal sensor 123 moving as opposed to motion from a human 185 in the space 120. For size and cost constraints, these capabilities can be built into the multi-modal sensor 123 using MEMS technology, but can be separate as well. The signal coming from the MEMS device can be used to cancel the undesirable vibrational signals 536A-N. For example, the magnitude and frequency of the vibration signals 536A-N can be detected and counteracted by cancelling out the vibration signals 536A-N, if vibration is present.

In addition, known sources of undesirable signals caused by vibration can be equipped with an accelerometer and gyroscope. The known vibrational signals 536A-N coming from those devices can be transmitted to the multi-modal sensor 123 and the vibrational signals 536A-N ignored by the occupancy sensing programming 164. Additionally, occupancy sensing programming 164 can implement machine learning to process the vibration signals 536A-N over time to determine heuristics to have a better understanding of the environment of a space 120 and tune sensitivity of a vibration sensing device to learn what the vibration profile is. The machine learning can be implemented when the system is initially set up or machine learning can be consistently and continuously executing in the occupancy sensing programming 164 to adjust the sensitivity of vibration detection of the vibration sensing device and learn as the application changes over time. In addition to implementing vibration detection, the machine learning can also be implemented to optimize power consumption of the radar sensor over time. For example, if one radar sensing technology consumes less power, then the less power consuming radar sensing technology may be selected.

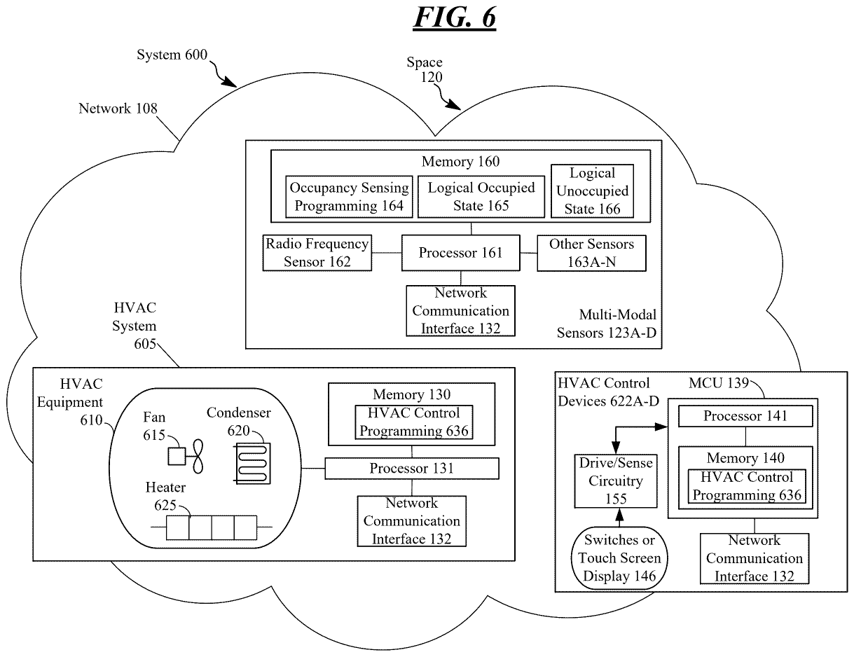

FIG. 6 depicts a system 600 like that of FIG. 1A, which includes multi-modal sensors 123A-D; however, the system 600 includes an HVAC system 605 instead of luminaires 121A-P and HVAC control devices 622A-D instead of lighting control devices 122A-D. As shown, the system 600 includes a heating, ventilation, and air conditioning (HVAC) system 605 for a space 120, including an HVAC equipment 610. The HVAC equipment 610 includes a heater 625; a fan 615; an air conditioner, such as a fan 615 and a condenser 620; or a combination thereof. The circuitry, hardware, and software of the HVAC control devices 622A-D is similar to the lighting control devices 122A-D of FIG. 1A, but include HVAC control programming 636 instead of lighting control programming 136 to control the HVAC system 605, including the HVAC equipment 610.

The multi-modal sensors 123A-D of the system 600 are like that described previously, but the occupancy sensing is for control of the HVAC system 605, including the HVAC equipment 610. For example, the multi-modal sensor 123 includes a radio frequency (RF) sensor 162; and at least one other sensor 163A-N including a passive infrared (PIR) sensor, a carbon dioxide sensor, an acoustic sensor, an ultrasonic sensor, a thermal sensor, an active infrared (IR) sensor, a camera, an image sensor, an accelerometer, a gyroscope, an inertial measurement unit (IMU), or an induction loop detector. The multi-modal sensor 123 further includes a memory 160; and a processor 161 coupled to the RF sensor 162, the at least one other sensor 163A-N, and the memory 160. Multi-modal sensor 123 further includes occupancy sensing programming 164 in the memory 160 for sensing occupancy and to communicate with other system elements, such as HVAC system 605, HVAC equipment 610, and HVAC control devices 622A-D.

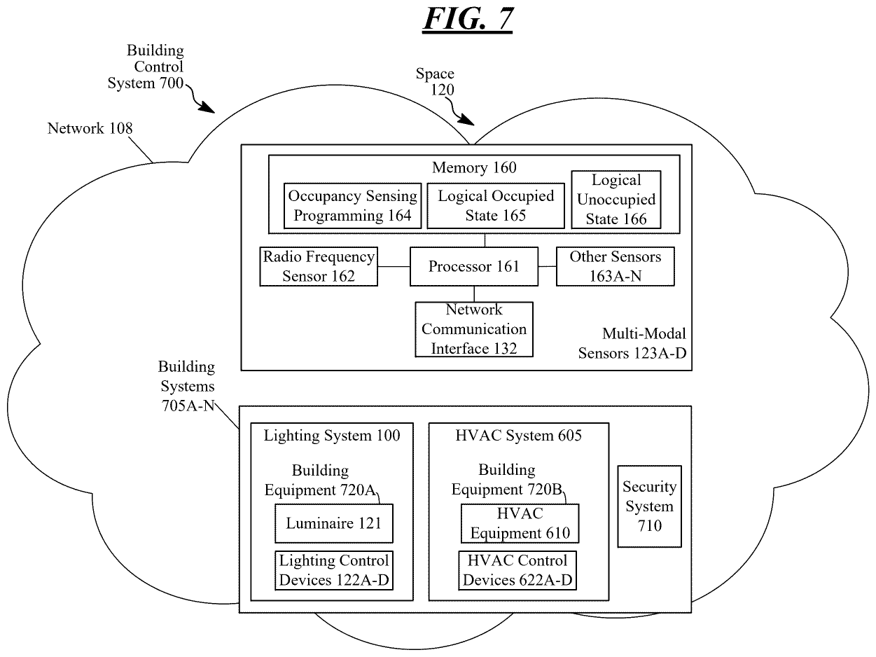

FIG. 7 depicts a building control system 700 like that of FIGS. 1A and 6, which includes multi-modal sensors 123A-D to control building systems 705A-N. As shown, the building control system 700 includes at least one building system 705A-N for a space 120. The at least one building system 705A-N includes a lighting system 100, an HVAC system 605, a security system 710, or a combination thereof. The at least one building system 705A-N includes building equipment 720A-B. The multi-modal sensors 123A-D of the building control system 700 are like that described previously, but the occupancy sensing is for control of the at least one building system 705A-N, such as the lighting system 100, HVAC system 605, the security system 710, or a combination thereof.

In FIG. 7, multi-modal sensors 123A-D are to control the building equipment 720A-B. For example, the at least one building system 705A-N includes the lighting system 100 and the building equipment 720A includes a luminaire 121. In another example, the at least one building system 705A-N includes the HVAC system 605 and the building equipment 720B includes HVAC equipment 610.

In both FIGS. 6-7, execution of the occupancy sensing programming 164 by the processor 161 configures the multi-modal sensor 123 to sense during an unoccupied state of the space 120, via one of the RF sensor 162 or the at least one other sensor 163A-N, a first transition to an occupied state of the space 120. Execution of the occupancy sensing programming 164 by the processor 161 configures the multi-modal sensor 123 to in response to sensing during the unoccupied state of the space 120 the first transition to the occupied state of the space 120, enter a logical occupied state 165 of the multi-modal sensor 123. Execution of the occupancy sensing programming 164 by the processor 161 configures the multi-modal sensor 123 to determine during the logical occupied state 165 of the multi-modal sensor 123, via the RF sensor 162, the at least one other sensor 163A-N, or both 162, 163A-N, a second transition to an unoccupied state of the space 120. Execution of the occupancy sensing programming 164 by the processor 161 configures the multi-modal sensor 123 to in response to determining during the logical occupied state 165 of the multi-modal sensor 123 the second transition to the unoccupied state of the space 120, enter a logical unoccupied state 166 of the multi-modal sensor 123.

In the examples above, the lighting system elements 104A-X, luminaires 121A-P, lighting control devices 122A-D, multi-modal sensors 123A-D, HVAC system 605, HVAC control devices 622A-D, etc. each include a network communication interface 132 for wired or wireless communication over one or more networks 108A-N. The networks 108A-N interconnect the links to/from the network communication interfaces 132A-N of the devices, so as to provide data communications amongst the lighting system elements 104A-X, luminaires 121A-P, lighting control devices 122A-D, multi-modal sensors 123A-D, HVAC system 605, HVAC control devices 622A-D, etc. Networks 108A-N may support data communication by equipment at the premises via wired (e.g., cable or fiber) media or via wireless (e.g., Wi-Fi, Bluetooth™, ZigBee, LiFi, IrDA, etc.) or combinations of wired and wireless technology. The multi-modal sensors 123A-D can be coupled to the other system elements, such as lighting system elements 104A-T, luminaires 121A-P, lighting control devices 122A-D, HVAC system 605, HVAC control devices 622A-D, etc. via line or low voltage analog signals as well as more advanced digital networks,

Any of the functionality of the occupancy sensing protocol 400, including occupancy sensing programming 164, lighting control programming 136, and HVAC control programming 636 described herein for the lighting system 100, system 600, building control system 700, lighting system elements 104A-X, luminaires 121A-P, lighting control devices 122A-D, multi-modal sensors 123A-D, HVAC system 605, HVAC control devices 622A-D, etc. can be embodied in one or more applications or firmware as described previously. According to some embodiments, “function,” “functions,” “application,” “applications,” “instruction,” “instructions,” or “programming” are program(s) that execute functions defined in the programs. Various programming languages can be employed to create one or more of the applications, structured in a variety of manners, such as object-oriented programming languages (e.g., Objective-C, Java, or C++) or procedural programming languages (e.g., C or assembly language).

In the examples above, the lighting system elements 104A-X, luminaires 121A-P, lighting control devices 122A-D, multi-modal sensors 123A-D, HVAC system 605, HVAC control devices 622A-D, etc. can each include a processor 131, 141, 161. As used herein, a processor 131, 141, 161 is a hardware circuit having elements structured and arranged to perform one or more processing functions, typically various data processing functions. Although discrete logic components could be used, the examples utilize components forming a programmable central processing unit (CPU). A processor 131, 141, 161 for example includes or is part of one or more integrated circuit (IC) chips incorporating the electronic elements to perform the functions of the CPU. The processors 131, 141, 161 for example, may be based on any known or available microprocessor architecture, such as a Reduced Instruction Set Computing (RISC) using an ARM architecture. Of course, other processor circuitry may be used to form the CPU or processor hardware in. The illustrated examples of the processors 131, 141, 161 can include one microprocessor or a multi-processor architecture. A digital signal processor (DSP) or field-programmable gate array (FPGA) could be suitable replacements for the processors 131, 141, 161, but may consume more power with added complexity.

The applicable processor 131, 141, 161 executes programming or instructions to configure the lighting system elements 104A-X, luminaires 121A-P, lighting control devices 122A-D, multi-modal sensors 123A-D, HVAC system 605, HVAC control devices 622A-D, etc. to perform various operations. For example, such operations may include various general operations (e.g., a clock function, recording and logging operational status and/or failure information) as well as various system-specific operations (e.g., energy management) functions. Although a processor 131, 141, 161 may be configured by use of hardwired logic, typical processors are general processing circuits configured by execution of programming, e.g., instructions and any associated setting data from the memories 130, 140, 160 shown or from other included storage media and/or received from remote storage media.

In the examples above, the lighting system elements 104A-X, luminaires 121A-P, lighting control devices 122A-D, multi-modal sensors 123A-D, HVAC system 605, HVAC control devices 622A-D, etc. each include a memory 130, 140, 160. The memory 130, 140, 160 may include a flash memory (non-volatile or persistent storage), a read-only memory (ROM), and a random access memory (RAM) (volatile storage). The RAM serves as short term storage for instructions and data being handled by the processors 131, 141, 161, e.g., as a working data processing memory. The flash memory typically provides longer term storage.

Of course, other storage devices or configurations may be added to or substituted for those in the example. Such other storage devices may be implemented using any type of storage medium having computer or processor readable instructions or programming stored therein and may include, for example, any or all of the tangible memory of the computers, processors or the like, or associated modules.

Hence, a machine-readable medium or a computer-readable medium may take many forms of tangible storage medium. Non-volatile storage media include, for example, optical or magnetic disks, such as any of the storage devices in any computer(s) or the like, such as may be used to implement the client device, media gateway, transcoder, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards, paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

According to exemplary embodiments of the present disclosure the one or more processors and control circuits can include one or more of any known general purpose processor or integrated circuit such as a central processing unit (CPU), microprocessor, field programmable gate array (FPGA), Application Specific Integrated Circuit (ASIC), Digital Signal Processor (DSP), or other suitable programmable processing or computing device or circuit as desired that is specially programmed to perform operations for achieving the results of the exemplary embodiments described herein. The processor(s) can be configured to include and perform features of the exemplary embodiments of the present disclosure, such as the occupancy sensing protocol 400 and the occupancy sensing programming 164. The features can be performed through program code encoded or recorded on the processor(s), or stored in a non-volatile memory device, such as Read-Only Memory (ROM), erasable programmable read-only memory (EPROM), or other suitable memory device or circuit as desired. Accordingly, such computer programs can represent controllers of the computing device.

In another exemplary embodiment, the program code, such as the occupancy sensing protocol 400 and the occupancy sensing programming 164, can be provided in a computer program product having a non-transitory computer readable medium, such as Magnetic Storage Media (e.g. hard disks, floppy discs, or magnetic tape), optical media (e.g., any type of compact disc (CD), or any type of digital video disc (DVD), or other compatible non-volatile memory device as desired) and downloaded to the processor(s) for execution as desired, when the non-transitory computer readable medium is placed in communicable contact with the processor(s).

The one or more processors 131, 141, 161 can be included in a computing system that is configured with components such as memory, a hard drive, an input/output (I/O) interface, a communication interface, a display and any other suitable component as desired. The exemplary computing device can also include a communications interface. The communications interface can be configured to allow software and data to be transferred between the computing device and external devices. Exemplary communications interfaces can include a modem, a network interface (e.g., an Ethernet card), a communications port, universal serial bus (USB), or any other suitable network communication interface as desired. Software and data transferred via the communications interface can be in the form of signals, which can be electronic, electromagnetic, optical, or other signals as will be apparent to persons having skill in the relevant art. The signals can travel via a communications path, which can be configured to carry the signals and can be implemented using wire, cable, fiber optics, a phone line, a cellular phone link, a radio frequency link, or any other suitable communication link as desired.

Where the present disclosure is implemented using programming or software, including the occupancy sensing protocol 400 and the occupancy sensing programming 164, the programming or software can be stored in a computer program product or non-transitory computer readable medium and loaded into the computing device using a removable storage drive or communications interface. In an exemplary embodiment, any computing device, such as the lighting system elements 104A-X, luminaires 121A-P, lighting control devices 122A-D, multi-modal sensors 123A-D, HVAC system 605, HVAC control devices 622A-D, etc. disclosed herein can also include a display interface that outputs display signals to a display unit, e.g., LCD screen, plasma screen, LED screen, DLP screen, CRT screen, or any other suitable graphical interface as desired.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” “has,” “having,” “containing,” “contain”, “contains,” “with,” “formed of,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element. Unless otherwise stated, the articles “a” or “an” preceding an element mean one or more of the elements.

Unless otherwise stated, any and all measurements, values, ratings, positions, magnitudes, sizes, angles, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as ±5% or as much as ±10% from the stated amount. The terms “approximately” and “substantially” mean that the parameter value or the like varies up to ±10% from the stated amount.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus, the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

What is claimed is:

1. A lighting system, comprising:
a luminaire, including a light source to emit illumination lighting for a space; and
a multi-modal sensor, including:
a radio frequency (RF) sensor;
at least one other sensor including a passive infrared (PIR) sensor, a carbon dioxide sensor, an acoustic sensor, an ultrasonic sensor, a thermal sensor, an active infrared (IR) sensor, a camera, an image sensor, an accelerometer, a gyroscope, an inertial measurement unit (IMU), or an induction loop detector;
a memory;
a processor coupled to the RF sensor, the at least one other sensor, and the memory; and
occupancy sensing programming in the memory, wherein execution of the occupancy sensing programming by the processor configures the multi-modal sensor to:
sense during an unoccupied state of the space, via one of the RF sensor or the at least one other sensor, a first transition to an occupied state of the space;
in response to sensing during the unoccupied state of the space the first transition to the occupied state of the space, enter a logical occupied state of the multi-modal sensor;
determine during the logical occupied state of the multi-modal sensor, via the RF sensor, the at least one other sensor, or both, a second transition to an unoccupied state of the space; and
in response to determining during the logical occupied state of the multi-modal sensor the second transition to the unoccupied state of the space, enter a logical unoccupied state of the multi-modal sensor.

2. The lighting system of claim 1, wherein:
the at least one other sensor includes the PIR sensor; and
the sensing during the unoccupied state of the space, via the one of the RF sensor or the at least one other sensor, the first transition to the occupied state of the space includes sensing during the unoccupied state of the space, via the PIR sensor, occupancy of the space by at least one human.

3. The lighting system of claim 2, wherein:
the RF sensor includes a radar sensor; and
the determining during the logical occupied state of the multi-modal sensor, via the RF sensor, the at least one other sensor, or both, the second transition to the unoccupied state of the space includes determining during the logical occupied state, via the radar sensor, non-occupancy of the space by the at least one human.

4. The lighting system of claim 1, wherein:
during the unoccupied state of the space, the RF sensor is in a low standby power mode; and
upon entering the logical occupied state of the multi-modal sensor, the RF sensor enters an active mode.

5. The lighting system of claim 1, wherein the determining during the logical occupied state, via the RF sensor, the at least one other sensor, or both, the second transition to the unoccupied state of the space includes determining that both of the RF sensor and the at least one other sensor have not detected occupancy of the space for a time period by at least one human.

6. The lighting system of claim 5, wherein the determining that both of the RF sensor and the at least one other sensor have not detected occupancy of the space for the time period by the at least one human includes:
combining occupancy detection signals from the RF sensor and the at least one other sensor into a combined signal;
comparing the combined signal against a combined occupancy threshold to detect the occupied state; and
determining that the combined signal does not satisfy the combined occupancy threshold during the time period.

7. The lighting system of claim 1, wherein the determining during the logical occupied state of the multi-modal sensor, via the RF sensor, the at least one other sensor, or both, the second transition to the unoccupied state of the space includes:
determining that the RF sensor has not detected occupancy of the space for a first time period by at least one human; and
determining that the at least one other sensor has not detected occupancy of the space for a second time period by the at least one human, wherein the second time period is greater than the first time period.

8. The lighting system of claim 1, wherein:
the sensing during the unoccupied state of the space, via the one of the RF sensor or the at least one other sensor, the first transition to the occupied state of the space includes sensing, via the RF sensor, occupancy of the space by at least human.

9. The lighting system of claim 8, wherein:
the at least one other sensor includes the carbon dioxide sensor; and
the determining during the logical occupied state of the multi-modal sensor, via the RF sensor, the at least one other sensor, or both, the second transition to the unoccupied state of the space includes determining, via the carbon dioxide sensor, non-occupancy of the space by the at least human.

10. The lighting system of claim 1, wherein the multi-modal sensor includes a network communication interface for communication over a network with the luminaire or the multi-modal sensor is integrated or housed inside of the luminaire.

11. The lighting system of claim 1, wherein the RF sensor includes a radar sensor.

12. A system, comprising:
a heating, ventilation, and air conditioning (HVAC) system for a space, including an HVAC equipment, wherein the HVAC equipment includes a heater, a fan, an air conditioner, or a combination thereof; and
a multi-modal sensor, including:
a radio frequency (RF) sensor;
at least one other sensor including a passive infrared (PIR) sensor, a carbon dioxide sensor, an acoustic sensor, an ultrasonic sensor, a thermal sensor, an active infrared (IR) sensor, a camera, an image sensor, an accelerometer, a gyroscope, an inertial measurement unit (IMU), or an induction loop detector;
a memory;
a processor coupled to the RF sensor, the at least one other sensor, and the memory; and
occupancy sensing programming in the memory, wherein execution of the occupancy sensing programming by the processor configures the multi-modal sensor to:
sense during an unoccupied state of the space, via one of the RF sensor or the at least one other sensor, a first transition to an occupied state of the space;
in response to sensing during the unoccupied state of the space, the first transition to the occupied state of the space, enter a logical occupied state of the multi-modal sensor;
determine during the logical occupied state of the multi-modal sensor, via the RF sensor, the at least one other sensor, or both, a second transition to an unoccupied state of the space; and
in response to determining during the logical occupied state of the multi-modal sensor, the second transition to the unoccupied state of the space, enter a logical unoccupied state of the multi-modal sensor.

13. A building control system, comprising:
at least one building system for a space, the at least one building system including a lighting system, an HVAC system, a security system, or a combination thereof, wherein the at least one building system includes building equipment; and
a multi-modal sensor to control the building equipment, including:
a radio frequency (RF) sensor;
at least one other sensor including a passive infrared (PIR) sensor, a carbon dioxide sensor, an acoustic sensor, an ultrasonic sensor, a thermal sensor, an active infrared (IR) sensor, a camera, an image sensor, an accelerometer, a gyroscope, an inertial measurement unit (IMU), or an induction loop detector;
a memory;
a processor coupled to the RF sensor, the at least one other sensor, and the memory; and
occupancy sensing programming in the memory, wherein execution of the occupancy sensing programming by the processor configures the multi-modal sensor to:
sense during an unoccupied state of the space, via one of the RF sensor or the at least one other sensor, a first transition to an occupied state of the space;
in response to sensing during the unoccupied state of the space, the first transition to the occupied state of the space, enter a logical occupied state of the multi-modal sensor;
determine during the logical occupied state of the multi-modal sensor, via the RF sensor, the at least one other sensor, or both, a second transition to an unoccupied state of the space; and
in response to determining during the logical occupied state of the multi-modal sensor, the second transition to the unoccupied state of the space, enter a logical unoccupied state of the multi-modal sensor.

14. The building control system of claim 13, wherein the at least one building system includes the lighting system and the building equipment includes a luminaire.

15. The building control system of claim 13, wherein the at least one building system includes the HVAC system and the building equipment includes HVAC equipment.

16. A non-transitory machine-readable medium, comprising:
occupancy sensing programming, wherein execution of the occupancy sensing programming configures a multi-modal sensor to:
sense during an unoccupied state of a space, via one of an RF sensor or at least one other sensor, a first transition to an occupied state of the space;
in response to sensing during the unoccupied state of the space the first transition to the occupied state of the space, enter a logical occupied state of the multi-modal sensor;
determine during the logical occupied state of the multi-modal sensor, via the RF sensor, the at least one other sensor, or both, a second transition to an unoccupied state of the space; and
in response to determining during the logical occupied state of the multi-modal sensor the second transition to the unoccupied state of the space, enter a logical unoccupied state of the multi-modal sensor.

17. The non-transitory machine-readable medium of claim 16, wherein:
the at least one other sensor includes a PIR sensor; and
the sensing during the unoccupied state of the space, via the one of the RF sensor or the at least one other sensor, the first transition to the occupied state of the space includes sensing during the unoccupied state of the space, via the PIR sensor, occupancy of the space by at least one human.

18. The non-transitory machine-readable medium of claim 17, wherein:
the RF sensor includes a radar sensor; and
the determining during the logical occupied state of the multi-modal sensor, via the RF sensor, the at least one other sensor, or both, the second transition to the unoccupied state of the space includes determining during the logical occupied state, via the radar sensor, non-occupancy of the space by the at least one human.

19. A method, comprising steps of:
sensing during an unoccupied state of a space, via one of an RF sensor or at least one other sensor, a first transition to an occupied state of the space;
in response to sensing during the unoccupied state of the space the first transition to the occupied state of the space, entering a logical occupied state of the multi-modal sensor;
determining during the logical occupied state of the multi-modal sensor, via the RF sensor, the at least one other sensor, or both, a second transition to an unoccupied state of the space; and
in response to determining during the logical occupied state of the multi-modal sensor the second transition to the unoccupied state of the space, entering a logical unoccupied state of the multi-modal sensor.

20. The method of claim 19, wherein:
the RF sensor includes a radar sensor; and
the determining during the logical occupied state of the multi-modal sensor, via the RF sensor, the at least one other sensor, or both, the second transition to the unoccupied state of the space includes determining during the logical occupied state, via the radar sensor, non-occupancy of the space by at least one human.
